(19) United States
(12) Patent Application Publication
(10) Pub. No.: US 2007/0024835 A1
(43) Pub. Date: Feb. 1, 2007

(54) Method for improving illumination uniformity in exposure process, and exposure apparatus

(76) Inventors: Kuo-Chun Huang, Tainan City (TW); Benjamin Szu-Min Lin, Hsinchu (TW); Te-Hung Wu, Sinshih Township (TW)

Correspondence Address: J C PATENTS, INC., 4 VENTURE, SUITE 250, IRVINE, CA, 92618, US

(21) Appl. No.: 11/195,269

(22) Filed: Aug. 1, 2005

(51) Int. Cl. G03B 27/54

(52) U.S. Cl. 355/67; 355/69

(57) ABSTRACT

A method for improving illumination uniformity in an exposure process is described, wherein a light source, a reticle and a projection system are used to expose a substrate in the exposure process. A realtime adjustable gray filter like a gray LCD panel is placed in the light path between the light source and the exposed substrate to compensate the illumination nonuniformity on the substrate in real time.

### BACKGROUND OF THE INVENTION

1. Field of the Invention

The present invention relates to lithography techniques. More particularly, the present invention relates to a method for improving illumination uniformity in an exposure process, and relates to an exposure apparatus that allows realtime control of illumination uniformity.

2. Description of the Related Art

In an IC fabricating process, the uniformity of critical dimension (CDU) is a very important issue for uniform performance of identical devices. One of the critical factors determining the CDU of patterns is the illumination uniformity in the exposure step of the lithography process that defines the patterns. Generally, when a positive photoresist material is used in a lithography process, the photoresist patterns in a region subject to stronger illumination in the exposure step have a smaller dimension.

The illumination uniformity in an exposure step may be deteriorated by certain factors, such as, degradation of the lenses in the exposure apparatus that is usually caused by long-term use. Therefore, the illumination distribution is monitored usually in an interval of months, and a gray filter of glass material is fabricated specifically according to the illumination nonuniformity to install in the exposure apparatus. The gray filter has a specific transmittance distribution that compensates the illumination nonuniformity, so that the resulting illumination distribution can be more uniform. However, since fabricating a conventional glass-based gray filter is quite time-consuming, the illumination uniformity cannot be improved immediately, and much time and money are wasted.

### SUMMARY OF THE INVENTION

In view of the foregoing, this invention provides a method for improving illumination uniformity in an exposure process that allows realtime control of the illumination uniformity.

This invention also provides an exposure apparatus that allows realtime control of illumination uniformity.

In the method for improving illumination uniformity in an exposure process of this invention, a realtime adjustable gray filter is placed in the optical path between the light source and the substrate. The transmittance distribution of the realtime adjustable gray filter is adjusted to compensate the illumination nonuniformity so that a more uniform illumination distribution can be obtained.

The exposure apparatus of this invention includes a light source, a reticle having patterns thereon, a projection system for projecting the patterns on the reticle to a substrate, and a realtime adjustable gray filter. The realtime adjustable gray filter is disposed in the light path between the light source and the substrate for compensating illumination nonuniformity on the substrate.

For operational convenience, the realtime adjustable gray filter is preferably electrically adjustable, and such a gray filter is, for example, a gray liquid-crystal display (LCD) panel. As known in the art, the transmittance of any pixel on a gray LCD panel can be easily and precisely controlled by adjusting the voltage applied across the electrodes of the pixel.

Since a realtime adjustable gray filter is used instead of the conventional glass gray filter in the exposure method and apparatus of this invention, the illumination nonuniformity can be compensated as soon as being measured. Therefore, a more uniform illumination distribution can be made to improve the uniformity in CD and device performance, and much time and money can be saved as compared with the method of the prior art.

It is to be understood that both the foregoing general description and the following detailed description are exemplary, and are intended to provide further explanation of the invention as claimed.

### BRIEF DESCRIPTION OF THE DRAWINGS

FIG. 1 schematically illustrates a configuration of an exposure apparatus according to a preferred embodiment of this invention.

FIG. 2 schematically illustrates a top view of a simplified gray LCD panel as one example of the realtime adjustable gray filter as well as the principles of adjusting the transmittance distribution according to the preferred embodiment of this invention.

### DESCRIPTION OF THE PREFERRED EMBODIMENTS

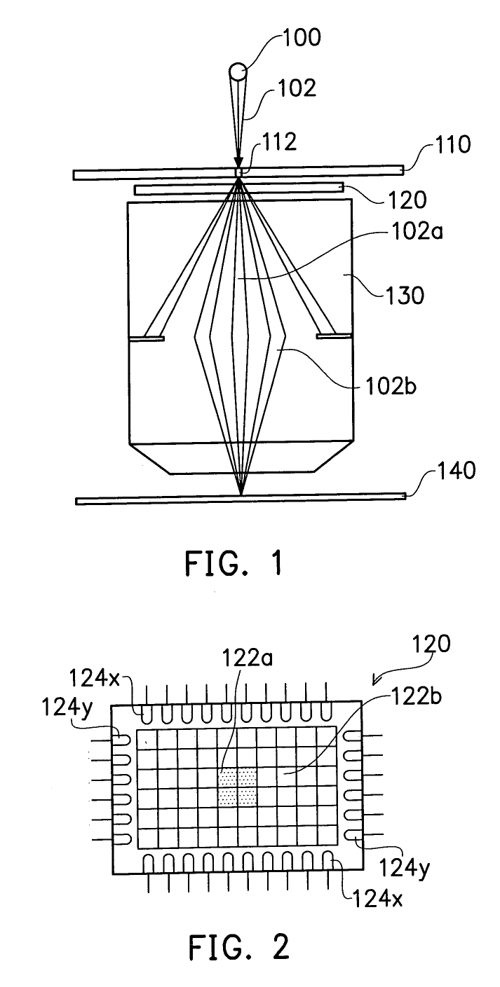

Referring to FIG. 1, the exposure apparatus according to a preferred embodiment of this invention includes a light source 100, a reticle 110, a realtime adjustable gray filter 120 and a projection system 130. The light source 100 may be an ultraviolet laser, such as, ArF-excimer laser of 193 nm or KrF-excimer laser of 248 nm. The reticle 110 has patterns thereon (not shown), which may include many gate line patterns having the same width. The light source 100 emits light 102 to scan the reticle 110 and thereby transfer the patterns thereon to the substrate 140 through the projection system 130, wherein the region of the reticle 110 illuminated at a moment is labeled with 112. The projection system 130 includes a lens set (not shown) for projecting a miniaturized image of the reticle patterns onto the photoresist layer (not shown) formed on the substrate 140, and the substrate 140 may be a semiconductor wafer like a silicon wafer.

The realtime adjustable gray filter 120 can be disposed anywhere in the optical path between the light source 100 and the substrate 140, but is preferably disposed between the light source 100 and the reticle 110 or between the projection system 130 and the reticle 110, as shown in FIG. 1. The transmittance distribution of the realtime adjustable gray filter 120 can be adjusted as soon as illumination nonuniformity is measured, so as to compensate the illumination nonuniformity and thereby make a more uniform illumination distribution.

To easily achieve the realtime adjustment, the realtime adjustable gray filter 120 is preferably an electrically adjustable one that can controlled by a computer, more preferably a gray LCD panel that is used in black/white LCD devices in the prior art. It is known that the transmittance of each pixel on an LCD panel can be independently adjusted by applying a specific voltage across the electrodes of the pixel, so as to make the required transmittance distribution over the whole LCD panel. The principles of adjusting the transmittance distribution are briefly described below with a simplified model.

FIG. 2 schematically illustrates a top view of a simplified gray LCD panel as one example of the realtime adjustable gray filter according to the preferred embodiment of this invention. The gray LCD panel 120 includes an array of pixels 122 and x-direction and y-direction control lines (not shown) with terminal electrodes 124x and 124y, from which required voltages are applied respectively. In the simplified model, the light 102 from the light source 100 is divided into central light 102a and side light 102b, as shown in FIG. 1, wherein the central light 102a passes the central pixels 122a on the gray LCD panel 120 and the side light 102b passes the side pixels 122b.

When the intensity (I₁) of the central light 102a is measured to be higher than that (I₂) of the side light 102b, required voltages are applied to the electrodes 124x and 124y respectively under the control of a computer. The voltages are applied such that the central pixels 122a have a transmittance (T₁) lower than that (T₂) of the side pixels 122b satisfying the equation of “I₁×T₁=I₂×T₂”, which means that after passing the gray LCD panel 120, the central light 102a and the side light 102b have the same intensity. The illumination nonuniformity thus can be compensated by the gray LCD panel 120 to achieve a uniform illumination distribution on the substrate 140.

In a real process, of course, the light intensity is measure at much more positions and the gray LCD panel as a realtime adjustable gray filter of this invention has much more pixels allowing a much more precise adjustment. Since various structures of LCD panel and various methods for controlling the transmittance of each pixel on a LCD panel are well known in the art, related descriptions can be easily found and are therefore omitted here.

As mentioned above, by using a realtime adjustable gray filter like a gray LCD panel in the method and apparatus of this invention, the illumination nonuniformity can be compensated as soon as being measured. Therefore, a more uniform illumination distribution can be made in real time to improve the uniformity in CD and device performance, and much time and money can be saved as compared with the method of the prior art.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

what is claimed is:

1. A method for improving illumination uniformity in an exposure process that uses a light source, a reticle and a projection system arranged in sequence to expose a substrate, comprising:
placing a realtime adjustable gray filter in a light path between the light source and the substrate to compensate illumination nonuniformity on the substrate.

2. The method of claim 1, wherein the realtime adjustable gray filter is electrically adjustable.

3. The method of claim 2, wherein the realtime adjustable gray filter comprises a gray LCD panel.

4. The method of claim 1, wherein the realtime adjustable gray filter is placed between the light source and the reticle.

5. The method of claim 1, wherein the realtime adjustable gray filter is placed between the reticle and the projection system.

6. An exposure apparatus, comprising:
a light source;
a reticle having patterns thereon;
a projection system for projecting the patterns on the reticle to a substrate; and
a realtime adjustable gray filter, disposed in a light path between the light source and the substrate for compensating illumination nonuniformity on the substrate.

7. The exposure apparatus of claim 6, wherein the realtime adjustable gray filter is electrically adjustable.

8. The exposure apparatus of claim 7, wherein the realtime adjustable gray filter comprises a gray LCD panel.

9. The exposure apparatus of claim 6, wherein the realtime adjustable gray filter is disposed between the light source and the reticle.

10. The exposure apparatus of claim 6, wherein the realtime adjustable gray filter is disposed between the reticle and the projection system.

11. Use of a gray LCD panel as a realtime adjustable gray filter in an exposure process.
